(19) United States
(12) Patent Application Publication
(10) Pub. No.: US 2012/0067485 A1
(43) Pub. Date: Mar. 22, 2012

(54) PNEUMATIC TIRE AND METHOD FOR MAKING A PNEUMATIC TIRE

(76) Inventors: Serge Julien Auguste Imhoff, (US); Frederic Gerard Auguste Siffer, Akron, OH (US); James Gregory Gillick, Akron, OH (US)

(21) Appl. No.: 12/885,899

(22) Filed: Sep. 20, 2010

(51) Int. Cl. B60C 9/00; B29D 30/08; B60C 9/18

(52) U.S. Cl. 152/451; 152/537; 156/117

(57) ABSTRACT

A pneumatic tire comprising a tire component having a plurality of individually plasma treated cords applied individually to the tire component, wherein the plasma treated cords comprise a plasma generated deposition derived from at least one polymerizable monomer.

### FIELD OF INVENTION

This invention relates to pneumatic tires and, in particular, to high performance automobile and motorcycle tires.

### BACKGROUND OF THE INVENTION

Conventional motorcycle tires utilize very wide treads which, in transverse cross-section, are sharply curved to provide good contact with the road surface when the motorcycle is steeply banked in cornering. Maintenance of a consistent ground contact area or ‘tire footprint’ under all conditions is a major factor in determining general vehicle handling. Of particular importance in race motorcycle tires of radial construction is a characteristic of high cornering power with stability to maximize cornering speeds under race conditions.

Conventional radial motorcycle race tires have short sidewalls which extend to the tread edges radially and axially outwardly from the tires beads. The beads provide engagement to the wheel rim on tapered bead seats. The sidewalls are reinforced by radial carcass plies which, when tensioned by the inflation pressure, act together with sidewall geometry to provide a fixed location for the curved tread regions to withstand cornering forces.

The sharply curved tread region of the conventional tire may be specially reinforced by a reinforcing breaker to give the required structural rigidity to allow for banking over of the motorcycle when cornering while also providing sufficient flexibility to allow localized tread flattening in the ground contact patch for good road grip.

A conventional motorcycle race tire may use a center hard tread compound and differing shoulder tread compounds since some race circuits necessitate uneven shoulder wear and grip.

Conventional processes for producing these tires involve an extrusion or calendering step which increase production cost and which may increase scrap. Any new and innovative manner of producing tires with reduced cost would be commercially desirable.

Rubber as used in tires is typically reinforced with various embodiments of textile, glass or steel fibers to provide basic strength, shape, stability, and resistance to bruises, fatigue, and heat. These fibers may be twisted into plies and cabled into cords. Rubber tires of various construction can be prepared using such cords.

Manufacturers of rubber reinforced articles have long realized the importance of the interfacial adhesion of reinforcement of its rubber environment. Specialized coatings such as resorcinol/formaldehyde latex adhesives for polymeric cords and brass plating for steel cords are typically applied to fiber and wire reinforcements to enable them to function effectively for tire use. In addition, the compounds used to coat these reinforcements are usually specially formulated to develop adhesion. For example, many tire manufacturers use various cobalt salts as bonding promoters in their steel cord wire coats. The bonding promoters are added through compounding. To achieve a maximum bonding strength, excessive amounts of cobalt salt are added to the wire coat. Since only a very small portion of the cobalt salt was engaged in the rubber-metal interfacial bonding reaction, most of the cobalt salts remained in the compound as excess cobalt without any contribution to the bonding. Cobalt is expensive and may even cause aging problems of the rubber when used in excess.

It continuously remains desirable to improve adhesion of tire cords to rubber while simultaneously improving the properties of the coat compounds and reducing their cost.

### Definitions

The following definitions are controlling for the disclosed invention.

“Apex” means an elastomeric filler element located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Circumferential” means lines or directions extending along the perimeter of the surface of the annular tire parallel to the Equatorial Plane (EP) and perpendicular to the axial direction.

“Cord” means one or more twisted or untwisted yarns such as an assembly of a plurality of twisted yarns. “Cords” may also be referred to as one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments, characterized by having a length at least 100 times its diameter or width.

“Filament count” means the number of filaments that make up a yarn. Example: 1000 denier polyester has approximately 190 filaments.

“High Tensile Steel (HT)” means a carbon steel with a tensile strength of at least 3400 MPa @ 0.20 mm filament diameter.

“Inner” means toward the inside of the tire and “outer” means toward its exterior.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa @ 0.20 mm filament diameter.

“Radial” and “radially” are used to mean directions radially toward or away from the axis of rotation of the tire.

“Sidewall” means that portion of a tire between the tread and the bead.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/ex or gm/denier). Used in textiles.

“Tensile” is stress expressed in forces/cross-sectional area. Strength in psi=12,800 times specific gravity times tenacity in grams per denier.

“Tread” means a molded, extruded, or shaped rubber component which, when bonded to a tire casing, includes that portion of the tire that comes into contact with the road when the tire is normally inflated and under normal load.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF INVENTION

The present invention is directed to a pneumatic tire comprising a tire component having a plurality of individually plasma treated cords applied individually to the tire component, wherein the plasma treated cords comprise a plasma generated deposition derived from at least one polymerizable monomer.

The invention is further directed to a method for constructing a pneumatic tire, said method comprising the steps of:

A) atomizing a mixture of at least one polymerizable monomer, a halogenated hydrocarbon, and a carrier gas to form an atomized mixture;

B) generating an atmospheric pressure plasma from the atomized mixture;

C) exposing an individual tire cord to the atmospheric pressure plasma to make a plasma treated cord; and

D) applying the plasma treated individual cord on a surface of an uncured tire component.

### BRIEF DESCRIPTION OF THE DRAWINGS

Further aspects of the present invention will become apparent from the description of the following embodiments in conjunction with the attached diagrammatic drawing in which:

FIG. 1 is a schematic representation of an example motorcycle tire for use with the present invention.

FIG. 2 is a schematic representation of tire cord treatment process of the present invention.

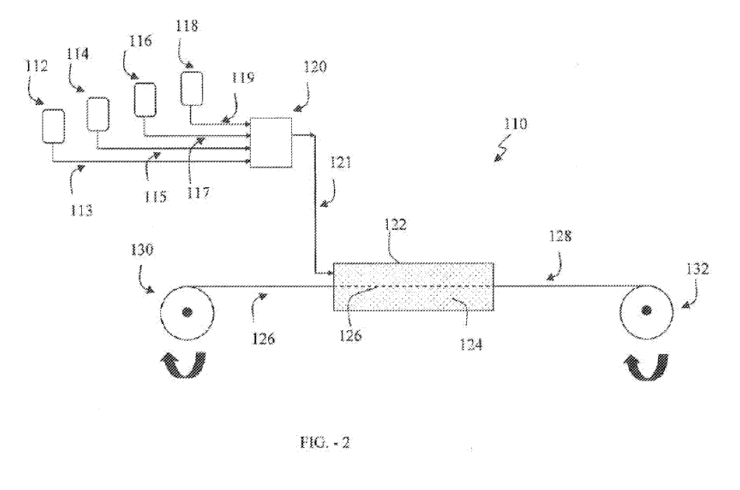

### DESCRIPTION

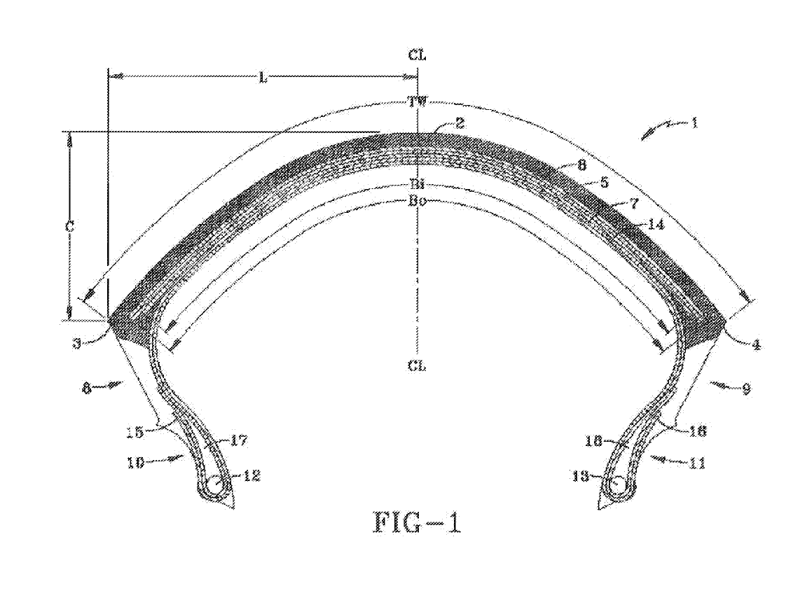

The example motorcycle tire 1 of FIG. 1 includes a pair of sidewalls 8, 9 terminating in bead regions 10, 11. Each bead region 10, 11 is reinforced by an inextensible annular bead core 12, 13. Extending between each bead region 12, 13 is a tire carcass reinforcement ply structure 14 of one or more plies which is/are anchored in each bead region by being turned around each respective bead core 12, 13 laterally from inside to outside to form each ply turn-up 15, 16. The carcass reinforcement ply structure 14 may, for example, comprise a single ply of nylon fabric cords oriented substantially in a radial direction. Each bead region 10, 11 may further comprise a hard rubber apex member 17, 18 anchored to each respective bead core 12, 13 and narrowing/tapering radially outward.

The carcass ply fabric of the example tire 1 may also comprise polyester, rayon, nylon, or para-aramid cords. Further, while a single ply carcass of cords at substantially 90 degrees may be particularly advantageous in the case of tires for the rear wheel of a motorcycle, for the front wheel, a motorcycle tire with two plies of cords crossed at an angle of 70-88 degrees may be utilized.

The example tire 1 may have a camber value of 0.6 and a convex tread region 2, having tread edges 3, 4 reinforced by a breaker assembly (or belt structure) and an overlay 8 in accordance with the present invention. The width TW of the tread may be 220 mm measured along the outer surface. The breaker assembly may comprise zero, one, or two breaker plies 5, 7. As an example, the breaker ply or plies 5, 7 may comprise para-aramid cord tire fabric or other suitable material and construction, such as a steel monofilament ply.

In the example tire 1 of FIG. 1, the cords in the two breaker plies 5, 7 may be oppositely inclined to each other at an angle of 25 degrees to the circumferential direction of the tire. The radially inner breaker ply 7 may have a width B₁ of 200 mm and may be narrower than the radially outer breaker ply 5, which may have a width Bₒ of 220 mm. The breaker plies 5, 7 may also comprise steel cords.

The tire cords of any of the various components of the tire, including but not limited to the belt structure (i.e., breaker), a carcass, an overlay, an undertread or a tread cushion layer may be treated using a plasma coating process, which includes the steps of

A) atomizing a mixture of at least one polymerizable monomer, a halogenated hydrocarbon, and a carrier gas to form an atomized mixture;

B) generating an atmospheric pressure plasma from the atomized mixture; and

C) exposing the tire cord to the atmospheric pressure plasma under conditions suitable to form a polymer strongly bonded to the tire cord and capable of bonding to rubber. Such tire cords may be made from any materials known in the art as suitable for tire cords, including but not limited to steel, aramid, PEN, PET, PVA, PBO, POK, rayon, nylon, carbon, and glass fiber.

With reference now to FIG. -2, one embodiment of a method of treating a tire cord according to the present invention is illustrated. In the process 110, carrier gas 113 is fed from storage vessel 112 to atomizer 120 along with monomer 115 from storage vessel 114, halogenated saturated hydrocarbon 117 from storage vessel 116. Optionally, one or more curatives 119 may be added from storage vessel 118. Carrier gas 113, monomer 115, halogenated saturated hydrocarbon 117 and optional curative 119 are atomized in atomizer 120 to form atomized mixture 121. Atomized mixture 121 is sent to plasma generator 122, where atmospheric plasma 124 is generated from atomized mixture 121. Tire cord 126 is unwound from spool 130 and conveyed through plasma generator 122 and atmospheric plasma 124 for deposition of a surface treatment by the plasma 124. Treated tire cord 128 exits plasma generator 122 and is wound onto spool 132 for storage.

The plasma generator may be any suitable plasma generation device as are known in the art to generate atmospheric pressure plasmas, such as atmospheric pressure plasma jet, atmospheric pressure microwave glow discharge, atmospheric pressure glow discharge, and atmospheric dielectric barrier discharge. In one embodiment, the plasma generator is of the dielectric barrier discharge type. The dielectric barrier discharge apparatus generally includes two electrodes with a dielectric-insulating layer disposed between the electrodes and operate at about atmospheric pressures. The dielectric barrier discharge apparatus does not provide one single plasma discharge, but instead provides a series of short-lived, self terminating arcs, which on a long time scale (greater than a microsecond), appears as a stable, continuous, and homogeneous plasma. The dielectric layer serves to ensure termination of the arc. Further reference may be made to U.S. Pat. No. 6,664,737 for its teaching regarding the operation of a dielectric barrier discharge apparatus.

By atmospheric pressure plasma, it is meant that the pressure of the plasma is equal to or slightly above the ambient pressure of the surroundings. The pressure of the plasma may be somewhat higher than ambient, such that the plasma pressure is sufficient to induce the desired flow rate through the atomizer and plasma generator.

The atomized mixture includes a carrier gas, at least one monomer, and a halogenated hydrocarbon.

Suitable carrier gas includes any of the noble gases including helium, argon, xenon, and neon. Also suitable as carrier gas are hydrogen, nitrogen, nitrous oxide, and carbon dioxide. In one embodiment, the carrier gas is argon. Blends of gases can also be used such as argon blended with one or more of nitrogen, carbon dioxide, helium or nitrous oxide where argon is the main gas and the one or more other gases is blended in the argon stream in amounts comprised between 0-5000 ppm; or a blend of nitrogen with one or more of carbon dioxide, helium, and nitrous oxide where nitrogen is the main gas and the one or more other gases is blended in the nitrogen stream in amounts comprised between 0-5000 ppm.

Suitable monomers include any of the various monomers used to produce elastomers for use in tires. Such monomers include conjugated diolefin monomers and vinyl aromatic monomers. The conjugated diolefin monomers generally contain from 4 to 12 carbon atoms. In particular 1,3-butadiene and isoprene may be used. Some additional conjugated diolefin monomers that can be utilized include 2,3-dimethyl-1,3-butadiene, piperylene, 3-butyl-1,3-octadiene, 2-phenyl-1,3-butadiene, and the like, alone or in admixture.

Further suitable are short chain length oligomers of polybutadiene and polyisoprene. Also suitable is squalene.

Some further representative examples of ethylenically unsaturated monomers that can potentially be used include alkyl acrylates, such as methyl acrylate, ethyl acrylate, butyl acrylate, methyl methacrylate and the like; vinylidene monomers having one or more terminal CH2=CH—groups; vinyl aromatics such as styrene, α-methylstyrene, bromostyrene, chlorostyrene, fluorostyrene and the like; α-olefins such as ethylene, propylene, 1-butene and the like; vinyl halides, such as vinylbromide, chloroethane (vinylchloride), vinylfluoride, vinyliodide, 1,2-dibromoethene, 1,1-dichloroethene (vinylidene chloride), 1,2-dichloroethene and the like; vinyl esters, such as vinyl acetate; α,β-olefinically unsaturated nitriles, such as acrylonitrile and methacrylonitrile; α,β-olefinically unsaturated amides, such as acrylamide, N-methyl acrylamide, N,N-dimethylacrylamide, methacrylamide and the like.

Vinyl aromatic monomers are another group of ethylenically unsaturated monomers which may be used. Such vinyl aromatic monomers typically contain from 8 to 20 carbon atoms. Usually, the vinyl aromatic monomer will contain from 8 to 14 carbon atoms. In one embodiment the vinyl aromatic monomer is styrene. Some examples of vinyl aromatic monomers that can be utilized include styrene, 1-vinylnaphthalene, 2-vinylnaphthalene, α-methylstyrene, 4-phenylstyrene, 3-methylstyrene and the like.

The amount of monomer may be expressed as a percent of the total components in the atomized mixture excluding the carrier gas, i.e. on a carrier gas free basis. In one embodiment, the amount of monomer ranges from 10 to 50 percent by weight of the total components in the atomized mixture on a carrier gas free basis. In one embodiment, the amount of monomer ranges from 20 to 40 percent by weight of the total components in the atomized mixture on a carrier gas free basis.

The atomized mixture also contains a halogenated hydrocarbon. Suitable halogenated hydrocarbon includes for example dichloromethane (methylene chloride). Other examples include trichloromethane (chloroform), carbon tetrachloride, trichloroethane, chlorobutane, bromoethane, dibromomethane (methylene bromide), tribromomethane (bromoform), and the like; as well as allyl bromide, allyl chloride, chlorinated isoprene, dichloro butene, dichloro propene, dichloro butyne, chlorobutene, 1-chloro-3-methyl-2-butene, 1-chloro-2-methylpropene, 1-chloro-2-octyne, and the like.

The amount of halogenated hydrocarbon may be expressed as a percent of the total components in the atomized mixture with the exception of the carrier gas, i.e., on a carrier gas free basis. In one embodiment, the amount of halogenated hydrocarbon ranges from 90 to 50 percent by weight of the total components in the atomized mixture on a carrier gas free basis. In one embodiment, the amount of halogenated hydrocarbon ranges from 80 to 60 percent by weight of the total components in the atomized mixture on a carrier gas free basis.

Optionally, the atomized mixture may include at least one curative, such as sulfur donors and accelerators. Examples of suitable curatives include sulfur vulcanizing agents such as elemental sulfur (free sulfur) or sulfur donating vulcanizing agents, for example, an amine disulfide, polymeric polysulfide, dialkyl polysulfides, alkyl thiols or sulfur olefin adducts. Alternatively, curatives may be absent from the material deposited on the tire cord from the atmospheric plasma. In this case, curatives present in a rubber composition contacted with the tire cord may serve to cure the deposited material via migration of the curatives from the rubber composition to the material deposited on the cord prior to cure. When used in the atomized mixture, curatives may be present in an amount ranging from 0.5 to 10 percent by weight on a carrier gas free basis.

The tire cord is constructed of any of the various reinforcement materials commonly used in tires. In one embodiment, the tire cord includes steel and polymeric cords. Polymeric cords may include any of the various textile cords as are known in the art, including but not limited to cords constructed from polyamide (nylon), polyester (PEN and PET), polyketone (POK), rayon, and polyaramid.

The tire cord is exposed to the atmospheric plasma for a time sufficient to deposit an adhesively effect amount of polymerized or partially polymerized monomer onto the cord surface. The plasma treated cords thereby comprise a plasma generated deposition derived from at least one polymerizable monomer. By adhesively effective amount, it is meant that the treated cord will show increased adhesion to a cured rubber compound as measured by a standard adhesion test, such as ASTM Standard D2229-73. Generally, the exposure time required will depend on the concentration of monomer in the atomized mixture, the flow rate of atomized mixture into the plasma generator, and the power input to the plasma generator. For a batch process wherein stationary cord is exposed to an atmospheric plasma, the cord is exposed for from 1 to 100 seconds. In a continuous process, the exposure time may be characterized by a residence time expressed as the cord path length (e.g. in centimeters) through the plasma generator divided by the cord transit rate (e.g. in cm/sec). The residence time in such a continuous process would then range from 1 to 100 seconds.

The flow rate of atomized mixture into the plasma generator necessary to obtain an adhesively effective amount of polymerized or partially polymerized monomer onto the cord surface will depend on the desired face velocity in the plasma generator, i.e., the gas velocity (e.g. in cm/sec) passing perpendicular to a characteristic internal cross-sectional area of the plasma generator. Necessary flow rate may be determined by one skilled in the art without undue experimentation.

It is readily understood by those having skill in the art that the rubber compositions used in tire components would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The rubber compound may contain various conventional rubber additives. In one embodiment, the addition of carbon black comprises about 10 to 200 parts by weight of diene rubber (phr). In another embodiment, from about 20 to about 100 phr of carbon black is used.

A number of commercially available carbon blacks may be used. Included in the list of carbon blacks are those known under the ASTM designations N299, N315, N326, N330, M332, N339, N343, N347, N351, N358, N375, N539, N550 and N582. Such processing aids may be present and can include, for example, aromatic, naphthenic, and/or paraffinic processing oils, as well as low PCA type oils including MES, TDAE, heavy naphthenic, RAE, and SRAE oils. Typical amounts of tackifying resins, such as phenolic tackifiers, range from 1 to 3 phr. Silica, if used, may be used in an amount of about 5 to about 100 phr, often with a silica coupling agent. Representative silicas may be, for example, hydrated amorphous silicas. Typical amounts of antioxidants comprise about 1 to about 5 phr. Representative antioxidants may be, for example, diphenyl-p-phenylenediamine, polymerized 1,2-dihydro-2,2,4-trimethylquinoline and others, such as, for example, those disclosed in the Vanderbilt Rubber Handbook (1990), Pages 343 through 362. Typical amounts of antiozonants comprise about 1 to about 5 phr. Representative antiozonants may be, for example, those disclosed in the Vanderbilt Rubber Handbook (1990), pages 363 through 367. Typical amounts of fatty acids, if used, which can include stearic acid comprise about 0.5 to about 3 phr. Typical amounts of zinc oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide, dialkyl polysulfides, alkyl thiols or sulfur olefin adducts. In one embodiment, the sulfur vulcanizing agent is elemental sulfur. One advantage of the present invention is the ability to use a relatively low sulfur content. In one embodiment, sulfur vulcanizing agents are used in an amount ranging from about 0.5 to about 8 phr. In another embodiment about 3 to about 5 phr of sulfur vulcanizing agents are used.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.5 phr. In another embodiment, combinations of two or more accelerators may be used, including a primary accelerator which is generally used in the larger amount (0.5 to 2.0 phr), and a secondary accelerator which is generally used in smaller amounts (0.05 to 0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. In another embodiment, if a second accelerator is used, the secondary accelerator may be a guanidine, dithiocarbamate or thiuram compound.

The rubber compound may contain any of the cobalt materials known in the art to further promote the adhesion of rubber to metal in the case of the use of steel tire cords. One advantage of the present invention is the reduction and possible elimination of cobalt compounds. However, it may be desirable to have some amounts that are present. Thus, suitable cobalt materials which may be employed include cobalt salts of fatty acids such as stearic, palmitic, oleic, linoleic and the like; cobalt salts of aliphatic or alicyclic carboxylic acids having from 6 to 30 carbon atoms, such as cobalt neodecanoate; cobalt chloride, cobalt naphthenate; cobalt carboxylate and an organo-cobalt-boron complex commercially available under the designation Manobond C from Wyrough and Loser, Inc, Trenton, N.J. Manobond C is believed to have the structure:

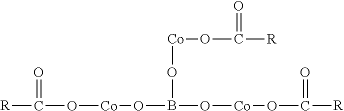

in which R is an alkyl group having from 9 to 12 carbon atoms.

Amounts of cobalt compound which may be employed depend upon the specific nature of the cobalt material selected, particularly the amount of cobalt metal present in the compound.

In one embodiment, the rubber composition is exclusive of cobalt compounds. In one embodiment, the amount of the cobalt material may range from about 0.2 to 5 phr. In another embodiment, the amount of cobalt compound may range from about 0.5 to 3 phr. In one embodiment, the amount of cobalt material present in the stock composition is sufficient to provide from about 0.01 percent to about 0.50 percent by weight of cobalt metal based upon total weight of the rubber stock composition. In another embodiment, the amount of cobalt material present in the stock composition is sufficient to provide from about 0.03 percent to about 0.2 percent by weight of cobalt metal based on total weight of wire coat composition.

The tire containing the tire component can be built, shaped, molded and cured by various methods which will be readily apparent to those having skill in such art.

A tire component of plasma treated cords in accordance with the present invention produces excellent handling performance in a tire 1, as well as reducing manufacturing cost. Further, a method in accordance with the present invention provides enhanced efficiency and reduced cost for constructing a pneumatic tire. Thus, the plasma treated cords and method both enhances the performance and/or manufacturing of a pneumatic tire, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry.

A pneumatic tire has certain essential structural elements. United States Department of Transportation, Mechanics of Pneumatic Tires, pages 207-208 (1981). These structural elements are typically made up of many flexible, high modulus cords of natural textile, synthetic polymer, glass fiber, or fine hard drawn steel or other metal embedded in, and bonded to, a matrix of low modulus polymeric material, usually natural or synthetic rubber. Id. at 207-208.

Tire manufacturers throughout the industry cannot agree or predict the effect of different twists of overlay cords on noise characteristics, handling, durability, comfort, etc. in pneumatic tires, Mechanics of Pneumatic Tires, pages 80-85.

These complexities are demonstrated by the below table of the interrelationships between tire performance and tire components.

| | LINER | CARCASS PLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, overlay cord characteristics affect the other components of a pneumatic tire (i.e., overlay affects apex, carcass ply, belt, tread, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the overlay of a pneumatic tire is modified with the intent to improve one functional property of the pneumatic tire, any number of other functional properties may be unacceptably degraded. Furthermore, the interaction between the overlay and the apex, carcass ply, belt (or breaker), and tread may also unacceptably affect the functional properties of the pneumatic tire. A modification of the overlay may not even improve that one functional property because of these complex interrelationships.

Thus, as stated above, the complexity of the interrelationships of the multiple components makes the actual result of modification of a tire component, in accordance with the present invention, impossible to predict or foresee from the infinite possible results. Only through extensive experimentation have the plasma treated cords of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising a tire component having a plurality of individually plasma treated cords applied individually to the tire component, wherein the plasma treated cords comprise a plasma generated deposition derived from at least one polymerizable monomer.

2. The pneumatic tire as set forth in claim 1 wherein the tire cord is made from a fiber material selected from steel, aramid, PEN, PET, PVA, PBO, POK, rayon, nylon, carbon, and glass.

3. The pneumatic tire as set forth in claim 1 wherein the cords are steel cords.

4. The pneumatic tire as set forth in claim 1 wherein the tire component is selected from the group consisting of a belt structure, a carcass, an overlay, an undertread or a tread cushion layer.

5. The pneumatic tire as set forth in claim 1 wherein a finish is applied to the plasma treated cords during or after a plasma process, the finish providing tack to the tire component.

6. The pneumatic tire as set forth in claim 1 wherein the tire component is an overlay disposed radially between the tread and a breaker or between the tread and at least one carcass ply.

7. The pneumatic tire as set forth in claim 1 wherein the cords are applied directly on to the tire component during a building process of an uncured pneumatic tire.

8. The pneumatic tire as set forth in claim 7 wherein the tire component is a belt structure.

9. The pneumatic tire as set forth in claim 1 wherein the at least one polymerizable monomer is selected from the group consisting of isoprene, butadiene, squalene, and styrene.

10. A method for constructing a pneumatic tire, said method comprising the steps of:
A) atomizing a mixture of at least one polymerizable monomer, a halogenated hydrocarbon, and a carrier gas to form an atomized mixture;
B) generating an atmospheric pressure plasma from the atomized mixture;
C) exposing an individual tire cord to the atmospheric pressure plasma to make a plasma treated cord; and
D) applying the plasma treated individual cord on a surface of an uncured tire component.

11. The method as set forth in claim 10 wherein the plasma treated individual cord is applied to the uncured tire component on a tire building drum.

12. The method as set forth in claim 10 wherein the uncured tire component is selected from a group consisting of: a carcass, a belt structure, an overlay, an undertread or a tread cushion layer.

13. The method as set forth in claim 10 wherein the plasma is generated by dielectric barrier discharge.

14. The method as set forth in claim 10 wherein said applying step occurs without calendering of the individual cord.

15. The method as set forth in claim 10 wherein the tire cord is a steel tire cord.

16. The method of claim 10, wherein the tire cord is conveyed continuously during exposure to the atmospheric pressure plasma.

17. The method of claim 1, wherein the carrier gas is selected from the group consisting of argon, helium, neon, xenon, oxygen, nitrogen, and carbon dioxide.

18. The method of claim 1, wherein the at least one polymerizable monomer is selected from the group consisting of isoprene, butadiene, squalene, and styrene.

19. The method of claim 1, wherein the atomized mixture further comprises at least one curative.

20. The method of claim 1, wherein the halogenated hydrocarbon is selected from the group consisting of dichloromethane (methylene chloride), trichloromethane (chloroform), carbon tetrachloride, trichloroethane, chlorobutane, bromoethane, dibromomethane (methylene bromide), tribromomethane (bromoform), allyl bromide, allyl chloride, chlorinated isoprene, dichloro butene, dichloro propene, dichloro butyne, chlorobutene, 1-chloro-3-methyl-2-butene, 1-chloro-2-methylpropene, and 1-chloro-2-octyne.
